(19) United States
(12) Patent Application Publication
(10) Pub. No.: US 2022/0385576 A1
(43) Pub. Date: Dec. 1, 2022

(54) METHOD AND SYSTEM FOR MIGRATION OF ONE OR MORE VIRTUAL MACHINES

(71) Applicant: FLIPKART INTERNET PRIVATE LIMITED, Karnataka (IN)

(72) Inventors: Krishna KUMAR, Karnataka (IN); Raghdipsingh Raghbirsingh PANESAR, Karnataka (IN); Varun Viswanathan NAIR, Karnataka (IN); Aftab Ahmad ANSARI, Vancouver (CA)

(21) Appl. No.: 17/750,856

(22) Filed: May 23, 2022

(30) Foreign Application Priority Data
May 27, 2021 (IN) 202141023633

(51) Int. Cl. H04L 45/76; H04L 67/1004

(52) U.S. Cl. CPC H04L 45/76; H04L 67/1004

(57) ABSTRACT

A system [100] and method [200] for migration of virtual machine(s). The method [200] encompasses identifying, the virtual machine(s) hosted under a first server unit configured in a network to migrate to a second server unit. The method [200] thereafter comprises broadcasting in the network, a GARP response generated by one of the virtual machine(s) and the first server unit. Further the method [200] comprises enabling, an IP forwarding on the second server unit. The method [200] thereafter encompasses enabling, a Proxy ARP on a first network node associated with the first server unit and a second network node associated with the second server unit. Further the method [200] comprises migrating, the virtual machine(s) to the second server unit from the first server unit based at least on the GARP, the enabled IP forwarding and the enabled Proxy ARP.

### TECHNICAL FIELD

The present disclosure generally relates to the field of Cloud Networking, and more particularly, to systems and methods for migration of one or more virtual machines to provide IP mobility across layer2 domains in layer3 fabric without overlays.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

With an immense growth in the field of cloud networking, migration of virtual machines has also gained more importance today. The migration of virtual machines helps to improve utilization of resources, isolate applications, tolerate faults in virtual machines, to raise efficiency of physical servers and to carry out maintenance to an underlying infrastructure without having to destroy the virtual machines hosted on the underlying infrastructure viz. physical server and recreate it elsewhere.

As datacenter scales have exponentially increased over the years, network fabrics have moved to a layer 3 network fabric model. In this model virtual machines/physical servers are provided with an IP address based on their placement in a network topology. This means, if a virtual machine is to be migrated from one section of a network to another section, it's not natively possible to provide the migrated virtual machine with the same IP address. Many applications/virtual machines depend on an IP address to be a unique identifier for communication and changing that would mean having to change application/virtual machine constructs. This would be vastly detrimental to activities that need to be carried out on an underlying infrastructure to achieve optimal utilization of resources, upgrades, security patches or any other kind of maintenance as they would require the applications/virtual machines to make changes.

Currently to achieve the optimal utilization of resources, upgrades, security patches or any other kind of maintenance, many large scale deployments of layer 3 fabrics where constructs like multi tenancy are essential (public clouds), deploy some form of overlay technology. VXLAN is one such example. The VXLAN standard enables overlay networks, enabling virtualized workloads to seamlessly communicate or move across server clusters and move data while retaining their original network identity. At its core, VXLAN is simply a MAC-in-UDP encapsulation (in other words, encapsulation of an Ethernet L2 Frame in IP) scheme, enabling creation of virtualized L2 subnets that can span physical L3 IP networks. More particularly, VXLAN enables connection between two or more L3 networks and makes it appear like they share the same L2 subnet. This allows virtual machines to operate in separate networks while operating as if they were attached to the same L2 subnet. VXLAN is an L2 overlay scheme over an L3 network. One of the limitation of this approach is the added complexity of managing a large scale overlay network as it has to deal with establishing another network, debugging, performance, etc.

Some other currently known solutions do not depend on the IP address as the network identifier; rather they use DNS records to identify endpoints. Thereby when a migration takes place, DNS records can be updated to reflect migration of virtual machines with a new IP address. One of the major limitation of this approach is the dependency on DNS, as many architectures like Java don't work and honor standard DNS constructs like TTL, thereby potentially leading to blips when executing the migration from client's perspective.

Although the existing technologies have provided various solutions for migration of one or more virtual machines but these currently known solutions have many limitations and therefore, there is a need for improvement in this area of technology and there is a requirement of an alternative to the existing solutions which are complicated to implement and manage.

### SUMMARY

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a solution for efficient and effective migration of one or more virtual machines from one physical server to another. Another object of the present invention is to provide a solution to efficiently and effectively migrate the virtual machines from one network node to another, wherein such network nodes belong to different network segment. Another object of the present invention is to provide an IP mobility across layer2 domains in layer3 fabric without overlays. Also, an object of the present invention is to provide a solution where no changes are required in clients or servers for migration of virtual machines. Another object of the present invention is to provide a solution which is completely transparent for all stacks. Yet another object of the present invention is to avoid the dependency on infrastructure services like DNS for migration of virtual machines.

In order to achieve the aforementioned objectives, the present invention provides a method and system for migration of one or more virtual machines. The method encompasses identifying, by an identification unit, the one or more virtual machines hosted under a first server unit in a network, wherein the one or more virtual machines are identified to migrate to a second server unit. The method thereafter comprises broadcasting, by a transceiver unit, a Gratuitous ARP response in the network, wherein the Gratuitous ARP response is generated by one of the one or more virtual machines and the first server unit. Further the method leads to enabling, by a processing unit, an IP forwarding on the second server unit to route one or more packets to the one or more virtual machines. The method thereafter encompasses enabling, by the processing unit, a Proxy ARP on a first network node and a second network node, wherein the first server unit is located under the first network node and the second server unit is located under the second network node. Further the method comprises migrating, by the processing unit, the one or more virtual machines to the second server unit from the first server unit based at least on the Gratuitous ARP, the IP forwarding enabled on the second server unit and the Proxy ARP enabled on the first network node and the second network node.

Another aspect of the disclosure relates to a system for migration of one or more virtual machines. The system comprises an identification unit, configured to identify, the one or more virtual machines hosted under a first server unit in a network, wherein the one or more virtual machines are identified to migrate to a second server unit. Further the system comprises a transceiver unit, configured to broadcast, a Gratuitous ARP response in the network, wherein the Gratuitous ARP response is generated by one of the one or more virtual machines and the first server unit. The system further comprises a processing unit, configured to enable, an IP forwarding on the second server unit to route one or more packets to the one or more virtual machines. The processing unit is thereafter configured to enable, a Proxy ARP on a first network node and a second network node, wherein the first server unit is located under the first network node and the second server unit is located under the second network node. Further the processing unit is configured to migrate, the one or more virtual machines to the second server unit from the first server unit based at least on the Gratuitous ARP, the IP forwarding enabled on the second server unit and the Proxy ARP enabled on the first network node and the second network node.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure.

FIG. 1 illustrates an exemplary block diagram of a system [100] for migration of one or more virtual machines, in accordance with exemplary embodiments of the present disclosure.

FIG. 2 illustrates an exemplary method flow diagram depicting a method [200] for migration of one or more virtual machines, in accordance with exemplary embodiments of the present disclosure.

FIG. 3 (i.e. FIG. 3a and FIG. 3b) illustrates an exemplary use case for migration of one or more virtual machines, in accordance with exemplary embodiments of the present disclosure.

The foregoing shall be more apparent from the following more detailed description of the embodiments of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As disclosed in the background section the existing technologies have many limitations and in order to overcome at least some of the limitations of the prior known solutions, the present disclosure provides a solution for migration of one or more virtual machines. In order to provide an efficient and effective migration of the one or more virtual machines, the present invention provides a mechanism to migrate the one or more virtual machines under a remote server unit with a network segment while retaining original network identifier (i.e. original IP address) of each virtual machine of the one or more virtual machines.

The present invention encompasses generation and broadcast of a Gratuitous ARP (Address Resolution Protocol) response to migrate the one or more virtual machines from one network segment to another. The present invention to migrate the one or more virtual machines also encompasses enabling a Proxy ARP (Address Resolution Protocol) on a network node from which the one or more virtual machines are to be migrated and on a network node to which the one or more virtual machines are to be migrated. Also, the present invention encompasses enabling an IP forwarding mechanism on a server unit under which the one or more virtual machines are to be migrated, to route one or more packets to and/or from the one or more virtual machines. The present invention to advertise an IP address of the one or more virtual machines after migration encompasses use of Border Gateway Protocol (BGP) peering between the server unit under which the one or more virtual machines are migrated and a network node under which said server unit is located.

The present invention provides a solution that uses existing layer 2 and layer 3 mechanisms to simulate an IP migration across layer 2 boundaries thereby positioning itself as an alternative to existing solutions that require use of overlay mechanisms and/or that are dependent on infrastructure services like DNS. Thus, the present solution eliminates the limitations of the existing solutions which are complicated to implement and manage. By migrating one or more virtual machines based on the implementation of the features of the present disclosure, the present invention provides a solution to the technical problem of change in original IP addresses of the one or more virtual machines during migration from one network section to another. Also, the present invention provides a solution to the technical problem of management of large scale overlay network that is required for migration of virtual machine/s. The present invention also provides a solution to the technical problem related to dependency on infrastructure services like DNS for migration of virtual machine/s.

Therefore, the present disclosure provides an efficient and effective solution to migrate one or more virtual machines from one network segment to another.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a server”, “a server device”, “a server machine”, “a server unit” and the like may be any electrical, electronic and/or computing device or equipment, capable of implementing the features of the present disclosure. The server device may contain at least one input means configured to receive an input from a user, a processing unit, an identification unit, a storage unit, a transceiver unit and any other such unit(s) which are capable of implementing the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least a data that may be required by one or more units of the system/user device to perform their respective functions.

The present disclosure is further explained in detail below with reference now to the diagrams.

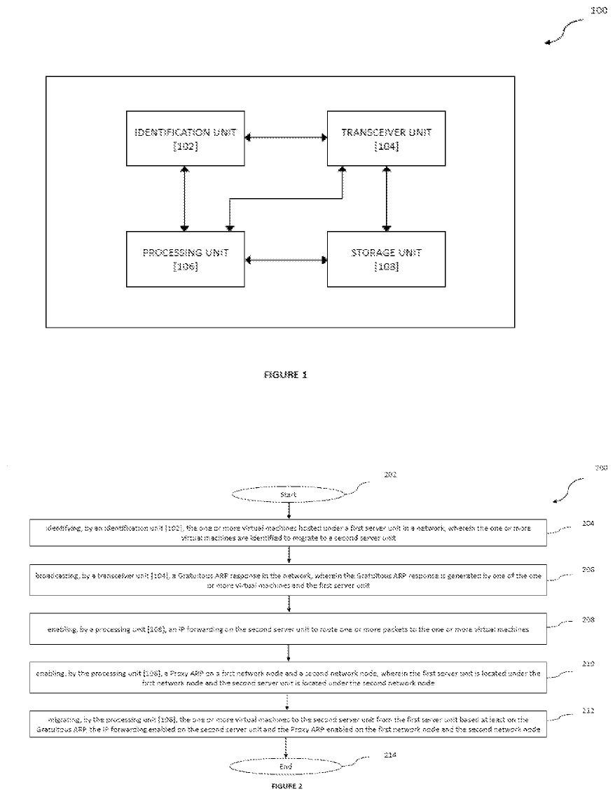

Referring to FIG. 1, an exemplary block diagram of a system [100] for migration of one or more virtual machines is shown. As shown in FIG. 1, the system encompasses at least one identification unit [102], at least one transceiver unit [104], at least one processing unit [106] and at least one storage unit [108]. All of the components/units of the system [100] are assumed to be connected to each other unless otherwise indicated below. Also, in FIG. 1 only a few units are shown, however, the system [100] may comprise multiple such units or the system [100] may comprise any such numbers of said units as required to implement the features of the present disclosure. In an implementation the system [100] is deployed on a server machine, wherein the server machine hosts the one or more virtual machines.

The system [100] is configured to migrate one or more virtual machines, with the help of the interconnection between its components/units.

The identification unit [102] is connected to the at least one transceiver unit [104], the at least one processing unit [106] and the at least one storage unit [108]. The identification unit [102] is configured to identify, the one or more virtual machines hosted under a first server unit in a network, wherein the one or more virtual machines are identified to migrate to a second server unit. More particularly, to identify the one or more virtual machines, the identification unit [102] is configured to identify, the first server unit i.e. a physical server that hosts the one or more virtual machines (i.e. the physical server from where the one or more virtual machines are to be migrated). The identification unit [102] is also configured to identify a first network node (for instance a first server rack switch) that hosts the first server unit, which in turns hosts the one or more virtual machines.

As, the identified one or more virtual machines are required to be migrate to the second server unit, the identification unit [102] is configured to identify the second server unit i.e. a physical server on which the one or more virtual machines are required to be migrated. The identification unit [102] is also configured to identify a second network node (for instance a second server rack switch) that hosts the second server unit, which in turn will host migrated one or more virtual machines.

The one or more virtual machines are identified to migrate to the second server unit from the first server unit while retaining their corresponding original IP addresses. The first server unit is located under the first network node and the second server unit is located under the second network node. The first network node has a network segment different from a network node under which the one or more virtual machines are required to be migrated i.e. the second network node associated with the second server unit. Therefore, the first network node and the second network node belong to different network segment.

The transceiver unit [104] is connected to the at least one identification unit [102], the at least one processing unit [106] and the at least one storage unit [108]. Once the one or more virtual machines are identified, the transceiver unit [104] is configured to broadcast, a Gratuitous ARP (Address Resolution Protocol) response in the network, wherein the Gratuitous ARP response is generated by one of the one or more virtual machines and the first server unit. The Gratuitous ARP response is generated to delete by the processing unit [106] from one or more neighboring virtual machines of the one or more virtual machines present in a same broadcast domain, a layer 2 information associated with the one or more virtual machines. The broadcasted Gratuitous ARP response is generated to delete an ARP (Address Resolution Protocol) information (i.e. the layer 2 information) for the one or more virtual machines on the other virtual machines under the first network node, before the migration of the one or more virtual machines begins. More particularly, Gratuitous ARP changes the ARP mapping of the one or more virtual machines on its neighbors in the same broadcast domain, from the one or more virtual machines' L2 address (i.e. mac address) to their default gateways L2 address (mac address) i.e. the first network node's L2 address. As used herein the “Gratuitous ARP” is an ARP (Address Resolution Protocol) Response that was not prompted by an ARP Request. The Gratuitous ARP is sent as a broadcast, as a way for a node (i.e. one of the one or more virtual machines and the first server unit in the present invention) to announce or update its IP to MAC mapping to an entire network. Generally, when a faulty/dead router is replaced by new one, it typically starts by sending a Gratuitous ARP to advertise itself as the new mapping to its neighbors. In the given case, a source virtual machine (i.e. the one or more virtual machines) sends a Gratuitous ARP where the mac address announced is of the default gateway i.e. the first network node. This is done to ensure there is no loss of availability from layer2 standpoint when the migration of such virtual machine takes place. Also, as used herein the “ARP (Address Resolution Protocol)” is a communication protocol used for discovering link layer address, such as a MAC address, associated with a given internet layer address, typically an IPv4 address.

The processing unit [106] is connected to the at least one identification unit [102], the at least one transceiver unit [104] and the at least one storage unit [108]. The processing unit [106] is configured to establish via the second server unit, a Border Gateway Protocol (BGP) peering between the second server unit and the second network node. As used herein the “Border Gateway Protocol (BGP)” is a protocol via which two routers that want to exchange route/reachability information establish a connection for exchanging BGP information, referred to as BGP peers. Such BGP peers (i.e. the second server unit and the second network node in the present invention) exchange routing information between them via BGP sessions that run over TCP, which is a reliable, connection oriented & error free protocol. The processing unit [106] establishes the BGP peering between the second server unit and the second network node before the one or more virtual machines are migrated to the second server unit and the second network node, so that it can advertise the one or more virtual machines' Layer 3 reachability information to an entire associated network fabric when the one or more virtual machines are migrated to the second server unit.

The processing unit [106] is also configured to enable, an IP forwarding on the second server unit. More particularly, to migrate the one or more virtual machines under the second server unit, the second server unit needs to act as a router forwarding packets for different broadcast domains, which further requires for the second server unit to enable IP_forwarding mode. Therefore, the processing unit [106] is configured to enable the IP forwarding on the second server unit to route one or more packets to the one or more virtual machines. As used herein the “IP forwarding” is an ability for an operating system to accept incoming network packets on one interface, identifying that it is not meant for a system itself, but it should be forwarded on to another network, and then onwards accordingly.

The processing unit [106] is further configured to enable, a Proxy ARP on the first network node and the second network node, wherein the first server unit is located under the first network node and the second server unit is located under the second network node. More particularly, as the one or more virtual machines after migration to the second server unit will reside in a different/new broadcast domain, the second network node that will have reachability information will need to proxy an ARP request for the one or more virtual machines and forward it to the corresponding next hop, which further requires the Proxy-ARP enabled on the second network node. Therefore, the processing unit [106] is configured to enable, the Proxy ARP on the second network node. Similarly, for reverse flow the first network node requires the Proxy-ARP enabled on it, therefore the processing unit [106] is also configured to enable, the Proxy ARP on the first network node. As used herein the “Proxy ARP” is a technique by which a proxy device on a given network answers ARP queries for an IP address that is not on that network. The proxy is aware of location of a traffic's destination, and offers its own MAC address as the destination.

Further, the processing unit [106] is configured to migrate, the one or more virtual machines to the second server unit from the first server unit based at least on the Gratuitous ARP, the IP forwarding enabled on the second server unit and the Proxy ARP enabled on the first network node and the second network node. Also, each virtual machine of the one or more virtual machines is migrated with its corresponding original network identifier.

Also, the processing unit [106] is further configured to advertise via the Border Gateway Protocol (BGP) peering, an IP address of the one or more virtual machines (i.e. the one or more virtual machines' Layer 3 reachability information) from the second server unit to the second network node based on the migration of the one or more virtual machines. The processing unit [106] is also configured to advertise via the Border Gateway Protocol (BGP) peering, the IP address of the one or more virtual machines (i.e. the one or more virtual machines' Layer 3 reachability information) from the second network node to an associated entire network. Also, at this point, all layer 3 nodes in the associated entire network fabric are aware how to route traffic for the one or more virtual machines i.e. forward it to the second network node which in turn forwards it to second server unit which should forward it to the one or more virtual machines. Therefore, at this point, the one or more virtual machines are successfully migrated to the destination second server unit located under the second network node, wherein such migration is based on the broadcasted Gratuitous ARP, the established Border Gateway Protocol (BGP) peering, the IP forwarding enabled on the second server unit and the Proxy ARP enabled on the first network node and the second network node.

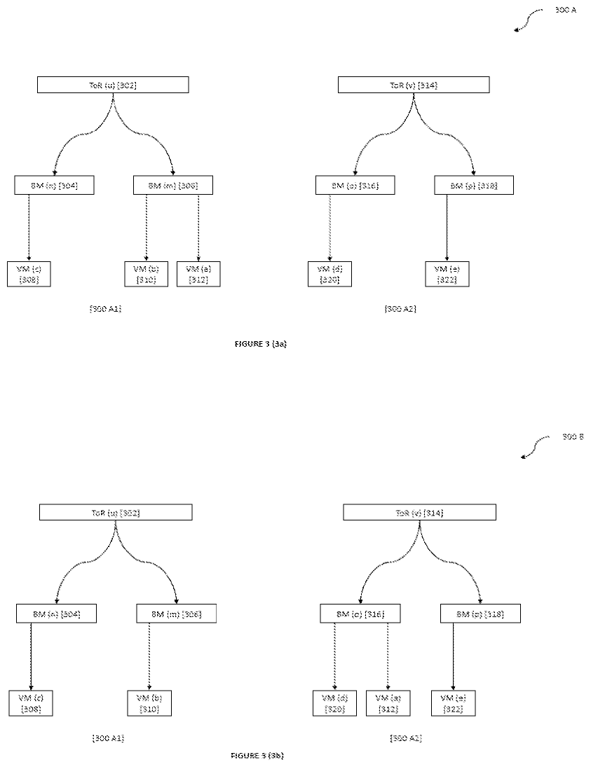

Referring to FIG. 2, an exemplary method flow diagram depicting a method [200] for migration of one or more virtual machines, in accordance with exemplary embodiments of the present disclosure is shown. In an implementation the method [200] is performed by a system [100]. As shown in FIG. 2, the method begins at step [202].

At step [204], the method comprises identifying, by an identification unit [102], the one or more virtual machines hosted under a first server unit in a network, wherein the one or more virtual machines are identified to migrate to a second server unit. More particularly, to identify the one or more virtual machines, the method encompasses identifying by the identification unit [102], the first server unit i.e. a physical server that hosts the one or more virtual machines (or the physical server from where the one or more virtual machines are to be migrated). The method also encompasses identifying by the identification unit [102], a first network node (for instance a first server rack switch) that hosts the first server unit, which in turns hosts the one or more virtual machines.

As, the identified one or more virtual machines are required to be migrate to the second server unit, the method encompasses identifying by the identification unit [102], the second server unit i.e. a physical server on which the one or more virtual machines are required to be migrated. The method also encompasses identifying by the identification unit [102], a second network node (for instance a second server rack switch) that hosts the second server unit, which in turn will host migrated one or more virtual machines.

The one or more virtual machines are identified to migrate to the second server unit from the first server unit while retaining their corresponding original IP addresses. The first server unit is located under the first network node and the second server unit is located under the second network node. The first network node has a network segment different from a network node under which the one or more virtual machines are required to be migrated i.e. the second network node associated with the second server unit. Therefore, the first network node and the second network node belong to different network segment.

Next, at step [206], once the one or more virtual machines are identified, the method comprises broadcasting, by a transceiver unit [104], a Gratuitous ARP response in the network, wherein the Gratuitous ARP response is generated by one of the one or more virtual machines and the first server unit. The Gratuitous ARP response is generated to delete by the processing unit [106] from one or more neighboring virtual machines of the one or more virtual machines present in a same broadcast domain, a layer 2 information associated with the one or more virtual machines. The broadcasted Gratuitous ARP response is generated to delete an ARP (Address Resolution Protocol) information (i.e. the layer 2 information) for the one or more virtual machines on the other virtual machines under the first network node, before the migration of the one or more virtual machines begins. More particularly, Gratuitous ARP changes the ARP mapping of the one or more virtual machines on its neighbors in the same broadcast domain, from the one or more virtual machines' L2 address (i.e. mac address) to their default gateways L2 address (mac address) i.e. the first network node's L2 address. As used herein the “Gratuitous ARP” is an ARP (Address Resolution Protocol) Response that was not prompted by an ARP Request. The Gratuitous ARP is sent as a broadcast, as a way for a node (i.e. one of the one or more virtual machines and the first server unit in the present invention) to announce or update its IP to MAC mapping to an entire network. Generally, when a faulty/dead router is replaced by new one, it typically starts by sending a Gratuitous ARP to advertise itself as the new mapping to its neighbors. In the given case, a source virtual machine (i.e. the one or more virtual machines) sends a Gratuitous ARP where the mac address announced is of the default gateway i.e. the first network node. This is done to ensure there is no loss of availability from layer2 standpoint when the migration of such virtual machine takes place. Also, as used herein the “ARP (Address Resolution Protocol)” is a communication protocol used for discovering link layer address, such as a MAC address, associated with a given internet layer address, typically an IPv4 address.

Further, the method encompasses establishing, by a processing unit [106] via the second server unit, a Border Gateway Protocol (BGP) peering between the second server unit and the second network node. As used herein the “Border Gateway Protocol (BGP)” is a protocol via which two routers that want to exchange route/reachability information establish a connection for exchanging BGP information, referred to as BGP peers. Such BGP peers (i.e. the second server unit and the second network node in the present invention) exchange routing information between them via BGP sessions that run over TCP, which is a reliable, connection oriented & error free protocol. The method comprises establishing by the processing unit [106], the BGP peering between the second server unit and the second network node before the one or more virtual machines are migrated to the second server unit and the second network node, so that the processing unit [106] can advertise the one or more virtual machines' Layer 3 reachability information to an entire associated network fabric when the one or more virtual machines are migrated to the second server unit.

Next, at step [208], the method comprises enabling, by the processing unit [106], an IP forwarding on the second server unit to route one or more packets to the one or more virtual machines. More particularly, to migrate the one or more virtual machines under the second server unit, the second server unit needs to act as a router forwarding packets for different broadcast domains, which further requires for the second server unit to enable IP_forwarding mode. Therefore, the method encompasses enabling by the processing unit [106], the IP forwarding on the second server unit to route one or more packets to the one or more virtual machines. Also as used herein the “IP forwarding” is an ability for an operating system to accept incoming network packets on one interface, identifying that it is not meant for a system itself, but it should be forwarded on to another network, and then onwards accordingly.

Next, at step [210], the method comprises enabling, by the processing unit [106], a Proxy ARP on the first network node and the second network node, wherein the first server unit is located under the first network node and the second server unit is located under the second network node. More particularly, as the one or more virtual machines after migration to the second server unit will reside in a different/new broadcast domain, in such scenario the second network node that will have reachability information, needs to proxy an ARP request for the one or more virtual machines and forward it to the corresponding next hop, which further requires the Proxy-ARP enabled on the second network node. Therefore, the method encompasses enabling by the processing unit [106], the Proxy ARP on the second network node. Similarly, for reverse flow the first network node requires the Proxy-ARP enabled on it, therefore the method also encompasses enabling the processing unit [106], the Proxy ARP on the first network node. As used herein the “Proxy ARP” is a technique by which a proxy device on a given network answers ARP queries for an IP address that is not on that network. The proxy is aware of location of a traffic's destination, and offers its own MAC address as the destination.

Thereafter, at step [212], the method comprises migrating, by the processing unit [106], the one or more virtual machines to the second server unit from the first server unit based at least on the Gratuitous ARP, the IP forwarding enabled on the second server unit and the Proxy ARP enabled on the first network node and the second network node. Also, each virtual machine of the one or more virtual machines is migrated with its corresponding original network identifier (i.e. corresponding original IP address).

Also, the method further comprises advertising by the processing unit [106] via the Border Gateway Protocol (BGP) peering, an IP address of the one or more virtual machines (i.e. the one or more virtual machines' Layer 3 reachability information) from the second server unit to the second network node based on the migration of the one or more virtual machines. The method also comprises advertising by the processing unit [106] via the Border Gateway Protocol (BGP) peering, the IP address of the one or more virtual machines (i.e. the one or more virtual machines' Layer 3 reachability information) from the second network node to an associated entire network. At this point, all layer 3 nodes in the associated entire network fabric are aware how to route traffic for the one or more virtual machines i.e. forward it to the second network node which in turn forwards it to second server unit which should forward it to the one or more virtual machines. Therefore, at this point, the one or more virtual machines are successfully migrated to the destination (i.e. the second server unit located under the second network node), wherein such migration is based on the broadcasted Gratuitous ARP, the established Border Gateway Protocol (BGP) peering, the IP forwarding enabled on the second server unit and the Proxy ARP enabled on the first network node and the second network node.

Thereafter, the method terminates at step [214].

Referring to FIG. 3 (i.e. FIG. 3a and FIG. 3b), an exemplary use case for migration of one or more virtual machines, in accordance with exemplary embodiments of the present disclosure is shown. More particularly, the FIG. 3a depicts a Pre Migration state of two network segments [300 A1] and [300 A2], where a virtual machine VM (a) [312] is to be migrated to the network segment [300 A2] from the network segment [300 A1]. Also, the FIG. 3b depicts a Post Migration state of the two network segments [300 A1] and [300 A2], where the virtual machine VM (a) [312] is successfully migrated to the network segment [300 A2] from the network segment [300 A1].

As depicted in FIG. 3a, the network segment [300 A1] encompasses virtual machines VM (c) [308], VM (b) [310] and VM (a) [312], wherein the virtual machines VM (b) [310] and VM (a) [312] are hosted under a physical server BM (m) [306] and the virtual machine VM (c) [308] is hosted under a physical server BM (n) [304]. Also, the network segment [300 A2] in FIG. 3a encompasses virtual machines VM (d) [320] and VM (e) [322], wherein the virtual machine VM (d) [320] is hosted under a physical server BM (o) [316] and the virtual machine VM (e) [322] is hosted under a physical server BM (p) [318].

Also, as the FIG. 3a depicts the Pre Migration state of two network segments [300 A1] and [300 A2], the VM (a) [312] hosted under BM (m) [306] needs to be migrated to BM (o) [316] while retaining its original IP address.

FIG. 3a also depicts that the physical server BM (m) [306] is located under a network node ToR (u) [302] and the physical server BM (o) [316] is located under a network node ToR (v) [314]. The network node ToR (u) [302] has a network segment different from the network node ToR (v) [314]. Hence the network segment of the physical server BM (o) [316] under which VM (a) [312] is supposed to be migrated to is different.

Further FIG. 3b (i.e. the Post Migration state), depicts that the network segment [300 A1] encompasses the virtual machines VM (c) [308] and VM (b) as the virtual machine VM (a) [312] is migrated to the network segment [300 A2] under BM (o) [316]. As indicated in the FIG. 3b, after migration of the virtual machine VM (a) [312], at the network segment [300 A1] the virtual machine VM (b) [310] is hosted under the physical server BM (m) [306] and the virtual machine VM (c) [308] is hosted under the physical server BM (n) [304].

Also, the network segment [300 A2] in FIG. 3b encompasses virtual machines VM (a) [312], VM (d) [320] and VM (e) [322], wherein the virtual machines VM (d) [320] and VM (a) [312] are hosted under the physical server BM (o) [316] and the virtual machine VM (e) [322] is hosted under the physical server BM (p).

Further, in order to provide a seamless migration of the virtual machine VM (a) [312] under the remote physical server BM (o) [316] while retaining the virtual machine's VM (a) [312] original network identifier (i.e. original IP address), the following steps are followed:

Step 1— One of the virtual machine VM (a) [312] and the physical server BM (m) [306], broadcasts a Gratuitous-ARP (GARP) to delete a layer 2 information i.e. ARP information for the virtual machine VM (a) [312] on the other VMs under TOR(u), before the migration begins. More specifically, the broadcasted GARP changes the ARP mapping of VM (a) [312] on neighbors in the same broadcast domain (eg: VM (b) [310] and VM (c) [308]) from VM (a)'s L2 address (i.e. mac address) to their default gateways L2 address (mac address) i.e. TOR (u)'s L2 address. This step further ensures that there is no loss of availability from layer2 standpoint when the migration of VM (a) [312] takes place.

Step 2— Before the virtual machine VM (a) [312] is migrated to the remote physical server BM (o) [316] and the network node ToR (v) [314], the BM (o) [316] establishes a BGP peering with the ToR (v) [314], such that it can advertise VM (a)'s [312] Layer 3 reachability information to an entire network fabric when it is migrated to the network segment [300 A2]. When the virtual machine VM (a) [312] is migrated to the remote physical server BM (o) [316] and the network node ToR (v) [314], the remote physical server BM (o) [316] thereby advertises VM (a)'s [312] Layer 3 reachability information to the entire network on the existing BGP session with the ToR (v) [314].

Step 3—Enable ip_forwarding mode on the physical server BM (o) [316]. As BM (o) [316] would need to act as a router forwarding packets for different broadcast domains and this requires for it to enable ip_forwarding mode, the ip_forwarding mode is enabled on the BM (o) [316].

After migration of the virtual machine VM (a) [312], for communication between virtual machine VM (a) [312] and other virtual machines such as the virtual machine VM (b) [310], the virtual machine VM (a) [312] assumes that the virtual machine VM (b) [310] is in the same broadcast domain as itself, hence it tries to reach the virtual machine VM (b) [310] by sending an ARP request for the virtual machine VM (b) [310] in its broadcast domain. Since the virtual machine VM (a) [312] now resides in a different broadcast domain, the network node ToR (v) [314] that has reachability information needs to proxy the ARP request for virtual machine VM (b) [310] and forward it to the corresponding next hop. This requires the network node ToR (v) [314] to have Proxy-ARP enabled. Similarly, for reverse flow, the network node ToR (u) [302], needs to have Proxy-ARP enabled. Therefore, at Step 4, the Proxy-ARP is enabled at the network node ToR (u) [302] and the network node ToR (v) [314].

Step 5— After enabling the Proxy-ARP at the network node ToR (u) [302] and the network node ToR (v) [314], at step 5 migrate the virtual machine VM (a) [312] to the BM (o) [316] and the ToR (v) [314].

After migration, the BM (o) [316] advertises the virtual machine VM (a) [312]'s Layer 3 reachability information to the entire network on the existing BGP session with the TOR (v) [314]. At this point, all layer 3 nodes in the network fabric are aware how to route traffic for the virtual machine VM (a) [312] i.e. forward it to the ToR (v) [314] which in turn forwards it to the BM (o) [316] which should forward it to the virtual machine VM (a) [312]. Therefore, at this point, the virtual machine VM (a) [312] is successfully migrated to the destination BM (o) [316].

Therefore, based on the implementation of the features of the present invention, when the VM (a) [312] is migrated out, there is no loss in availability from the perspective of VM (b) [310] and VM (c) [308] as the proxy ARP kicks in when local VM (a) [312] is migrated out and TOR (u) [302] now has reachability information using routes received via the existing BGP session.

Furthermore, an exemplary IP communication between the virtual machine VM (a) [312] and the virtual machine VM (b) [310] is shown below in both Pre Migration and Post Migration states:

Pre Migration:

VM (a) [312]-VM (b) [310]->IP communication
[a.a.a.a][aa:aa:aa:aa:aa:aa]-[b.b.b.b][ff:ff:ff:ff:ff:ff]

->arp request
[b.b.b.b][bb:bb:bb:bb:bb:bb]-[a.a.a.a][aa:aa:aa:aa:aa:aa]

->arp response
[a.a.a.a][aa:aa:aa:aa:aa:aa]-[b.b.b.b][bb:bb:bb:bb:bb:bb]

->L2 frame structure

Post Migration:

Forward Communication:
[a.a.a.a][aa:aa:aa:aa:aa:aa]-[b.b.b.b][ff:ff:ff:ff:ff:ff]

->arp request
[b.b.b.b][vv:vv:vv:vv:vv:vv]-[a.a.a.a][aa:aa:aa:aa:aa:aa]

->arp response spoofed by TOR{v}
[a.a.a.a][aa:aa:aa:aa:aa:aa]-[b.b.b.b][vv:vv:vv:vv:vv:vv]

>L2 frame structure destined for TOR{v}

Reverse Communication:
[b.b.b.b][bb:bb:bb:bb:bb:bb]-[a.a.a.a][ff:ff:ff:ff:ff:ff]

->arp request
[a.a.a.a][uu:uu:uu:uu:uu:uu]-[b.b.b.b][bb:bb:bb:bb:bb:bb]

->arp response spoofed by TOR{u}
[b.b.b.b][bb:bb:bb:bb:bb:bb]-[a.a.a.a][uu:uu:uu:uu:uu:uu]

->L2 frame structure destined for TOR{u}

As evident from the above disclosure, the present solution provides significant technical advancement over the existing solutions by efficiently and effectively migrating one or more virtual machines from one network section to another. Also, by migrating one or more virtual machines based on the implementation of the features of the present disclosure, the present invention provides a solution to the technical problem of change in original IP addresses of the one or more virtual machines during migration from one network section to another, as the present invention provides a solution to migrate the one or more virtual machines with their corresponding original IP addresses. Also, the present invention provides a solution to the technical problem of management of large scale overlay networks that are required for migration of virtual machine/s. The present invention also provides a solution to the technical problem related to dependency on infrastructure services like DNS for migration of virtual machine/s.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for migration of one or more virtual machines, the method comprising:
identifying, by an identification unit [102], the one or more virtual machines hosted under a first server unit in a network, wherein the one or more virtual machines are identified to migrate to a second server unit;
broadcasting, by a transceiver unit [104], a Gratuitous ARP response in the network, wherein the Gratuitous ARP response is generated by one of the one or more virtual machines and the first server unit;
enabling, by a processing unit [106], an IP forwarding on the second server unit to route one or more packets to the one or more virtual machines;
enabling, by the processing unit [106], a Proxy ARP on a first network node and a second network node, wherein the first server unit is located under the first network node and the second server unit is located under the second network node; and
migrating, by the processing unit [106], the one or more virtual machines to the second server unit from the first server unit based at least on the Gratuitous ARP, the IP forwarding enabled on the second server unit and the Proxy ARP enabled on the first network node and the second network node.

2. The method as claimed in claim 1, wherein the Gratuitous ARP response is generated to delete by the processing unit [106] from one or more neighboring virtual machines of the one or more virtual machines present in a same broadcast domain, a layer 2 information associated with the one or more virtual machines.

3. The method as claimed in claim 1, wherein the first network node and the second network node belong to different network segment.

4. The method as claimed in claim 1, wherein each virtual machine of the one or more virtual machines is migrated with its corresponding original network identifier.

5. The method as claimed in claim 1, the method comprises establishing, by the processing unit [106] via the second server unit, a Border Gateway Protocol (BGP) peering between the second server unit and the second network node.

6. The method as claimed in claim 5, the method comprises advertising by the processing unit [106] via the Border Gateway Protocol (BGP) peering, an IP address of the one or more virtual machines from the second server unit to the second network node based on the migration of the one or more virtual machines.

7. The method as claimed in claim 6, the method comprises advertising by the processing unit [106] via the Border Gateway Protocol (BGP) peering, the IP address of the one or more virtual machines from the second network node to an associated entire network.

8. A system for migration of one or more virtual machines, the system comprising:
an identification unit [102], configured to identify, the one or more virtual machines hosted under a first server unit in a network, wherein the one or more virtual machines are identified to migrate to a second server unit;
a transceiver unit [104], configured to broadcast in the network, a Gratuitous ARP response, wherein the Gratuitous ARP response is generated by one of the one or more virtual machines and the first server unit; and
a processing unit [106], configured to:
enable, an IP forwarding on the second server unit to route one or more packets to the one or more virtual machines,
enable, a Proxy ARP on a first network node and a second network node, wherein the first server unit is located under the first network node and the second server unit is located under the second network node, and
migrate, the one or more virtual machines to the second server unit from the first server unit based at least on the Gratuitous ARP, the IP forwarding enabled on the second server unit and the Proxy ARP enabled on the first network node and the second network node.

9. The system as claimed in claim 8, wherein the Gratuitous ARP response is generated to delete by the processing unit [106] from one or more neighboring virtual machines of the one or more virtual machines present in a same broadcast domain, a layer 2 information associated with the one or more virtual machines.

10. The system as claimed in claim 8, wherein the first network node and the second network node belong to different network segment.

11. The system as claimed in claim 8, wherein each virtual machine of the one or more virtual machines is migrated with its corresponding original network identifier.

12. The system as claimed in claim 8, wherein the processing unit [106] is further configured to establish via the second server unit, a Border Gateway Protocol (BGP) peering between the second server unit and the second network node.

13. The system as claimed in claim 12, wherein the processing unit [106] is further configured to advertise via the Border Gateway Protocol (BGP) peering, an IP address of the one or more virtual machines from the second server unit to the second network node based on the migration of the one or more virtual machines.

14. The system as claimed in claim 13, wherein the processing unit [106] is further configured to advertise via the Border Gateway Protocol (BGP) peering, the IP address of the one or more virtual machines from the second network node to an associated entire network.
